(19) United States
(12) Patent Application Publication
(10) Pub. No.: US 2018/0209602 A1
(43) Pub. Date: Jul. 26, 2018

(54) CONVERTER, LASER-ACTIVATED REMOTE PHOSPHOR (LARP) SYSTEM, HEADLIGHT AND METHOD

(71) Applicant: OSRAM GmbH, Munich (DE)

(72) Inventor: Patrick Kerscher, Bernhardswald (DE)

(21) Appl. No.: 15/873,958

(22) Filed: Jan. 18, 2018

(30) Foreign Application Priority Data
Jan. 20, 2017 (DE) 10 2017 101 091.2

(51) Int. Cl. F21S 41/16; F21S 41/20; F21K 9/64

(52) U.S. Cl. CPC F21S 41/16; F21K 9/64; F21S 41/285

(57) ABSTRACT

A converter for a laser-activated remote phosphor system includes a phosphor for at least partially converting excitation radiation from a radiation source of the laser-activated remote phosphor system, and a substrate on which the phosphor is fixed. The phosphor and the substrate are connected by way of bonding.

### CROSS-REFERENCE TO RELATED APPLICATION

This application claims priority to German Patent Application Serial No. 10 2017 101 091.2, which was filed Jan. 20, 2017, and is incorporated herein by reference in its entirety.

### TECHNICAL FIELD

Various embodiments relate generally to a laser-activated remote phosphor (LARP) system and a headlight having such a system. Various embodiments furthermore relate to a converter in a LARP system, and to a method for producing the converter.

### BACKGROUND

In LARP technology, a conversion element or converter that has a phosphor, or is made of a phosphor, and is arranged at a distance from a radiation source is irradiated with excitation radiation, e.g. an excitation beam (pump beam, pump laser beam), e.g. with the excitation beam from a laser diode. The excitation radiation of the excitation beam is at least partially absorbed by the phosphor and at least partially converted into conversion radiation having wavelengths and thus spectral properties and/or a color that are determined by the conversion properties of the phosphor. By way of example, it is thus possible using the conversion element to convert blue excitation radiation (blue laser light, for example in the wavelength range 445 to 465 nm) into red and/or green and/or yellow conversion radiation (conversion light). In the case of partial conversion, a superposition of non-converted blue excitation light and yellow conversion light then gives used white light, for example.

In order to convert the laser radiation, a converter is used, as described above, which has a substrate, for example a thin sapphire plate, having a phosphor. Conventionally, the substrate and the phosphor are connected to one another using a silicone adhesive layer, which can be damaged, e.g. burned, by way of the laser light during the use of the converter, however. This can result in a dark discoloration of the silicone, what is known as a dark spot. This defect can significantly shorten the lifetime of the converter or render it unusable, for example because of the formation of thermal stresses in the substrate and/or in the phosphor and cracks or tears that develop as a result, a reduction in the light output due to a discoloration of the silicone adhesive layer, and also safety-relevant aspects due to the substrate possibly falling off or flaking off the phosphor, because in that case, a high degree of tightly bundled, unconverted excitation radiation can leave the LARP system (damage to an observer's eyes).

In order to prevent this, LARP systems are currently operated at a lower output than would be technically possible.

### SUMMARY

A converter for a laser-activated remote phosphor system includes a phosphor for at least partially converting excitation radiation from a radiation source of the laser-activated remote phosphor system, and a substrate on which the phosphor is fixed. The phosphor and the substrate are connected by way of bonding.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1A to 1D show in each case a process of a method for producing a converter.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide a converter, a laser-activated remote phosphor (LARP) system and a headlight that have a comparatively high lifetime. Furthermore, various embodiments provide a cost-effective method for producing a converter with which the converter has a comparatively high lifetime.

According to various embodiments, a converter for a laser-activated remote phosphor (LARP) system is provided, which is equipped with a phosphor for partially or completely converting excitation radiation from a radiation source and with a substrate, on which the phosphor is attached. The phosphor and the substrate may be connected to each other by way of bonding. The substrate is preferably a sapphire plate having a high thermal conductivity. The thickness of the sapphire plate can range from about 0.5 mm to about 2 mm.

Various embodiments may have the effect that adhesive, such as silicone adhesive, is no longer necessary between the phosphor and the substrate. As a result, for example burning of the adhesive between the phosphor and the substrate and the associated brown discolorations, can be avoided by changing or omitting the adhesive layer. In addition, the omission of the adhesive layer results in a more cost-effective and less complex converter in terms of apparatus.

Various embodiments may furthermore allow for the resilience, for example with respect to temperature and/or radiation density, to be increased as compared to silicone-based adhesive connections. It may consequently be feasible for the output e.g. in terms of luminance and/or optical flow (total luminous flux of the used light) to increase. Furthermore, better thermal bonding of the phosphor to the substrate can effect an increase in the usable operating time.

Direct bonding describes e.g. a technology for joining planar bodies without additional substances such as adhesives or solder, merely by way of direct mechanical contact, wherein no further layer is necessary between the two materials. In the case of direct bonding, smooth surfaces can be brought into contact at high temperatures. An optimum bonding process can take place when the contact surfaces have a macroscopic planarity of the surfaces and a microscopic smoothness. The basis for the mechanical connection are, for example, hydrogen bridges and Van der Waals interactions in the region of the contact zone.

Feasible is that the phosphor and the substrate are produced in the form of plates. Furthermore, the contact surfaces of the phosphor and the substrate may in each case be of identical size, which results in an improved connection and an improved bonding process.

On the excitation-side, a layer can be applied on the phosphor, e.g. a glass layer, e.g. a silicon glass layer, for example a low-refractive SiO₂ layer. In a further configuration, a layer, e.g. a dichroic layer, which faces the phosphor can be applied on the substrate. The dichroic layer may be configured such that it substantially transmits the excitation radiation and substantially reflects the conversion light produced in the downstream phosphor. The outermost stratum or strata of the dichroic coating can likewise be a glass layer, in particular a silicon glass layer. The thickness of the dichroic layer, i.e. of the dichroic layer stack, may be in the range of 2.5 μm to 5.0 μm, and may have at most 40 layer sequences. Formable between the glass layer and the remaining substrate are, if necessary, in addition to the dichroic layer, one or more additional layers, for example an anti-reflective coating for the excitation radiation. The substrate (e.g. sapphire plate) can also have an anti-reflective coating, which faces the excitation source, for the excitation light.

The layer on the substrate and/or on the phosphor may improve the surface quality of the contact-side surface(s) of the phosphor and/or the substrate. An improved bonding method may become possible due to the low roughness and good planarity of the contact surfaces.

The dichroic layer on the substrate additionally permits complete or partial passage of the excitation radiation from the radiation source to the phosphor and prevents reflection, e.g. of conversion radiation.

Provided according to various embodiments is a method for producing a converter, e.g. in accordance with one or more of the preceding aspects. The method can involve joining of the above-mentioned converter by way of direct bonding.

For the direct bonding method, the phosphor and/or the substrate can be coated with the abovementioned layer or layers. Provided as the contact surfaces can then be the glass layer in the case of the phosphor and the outermost stratum of the dichroic layer, which may likewise be a glass layer, in the case of the substrate. This may have the effect that problems that can occur during bonding of different materials are avoided.

In the further course of the method, the substrate and the phosphor are arranged relative to one another, e.g. having a parallel spacing of approximately 1 mm, and are aligned such that the respective contact surfaces of the substrate and the phosphor face one another. The contact surfaces can be arranged on top of one another. Furthermore, the contact surfaces can in each case extend horizontally. Maintenance of the spacing can be ensured using spacers.

By way of example, the phosphor is arranged with the contact surface pointing up and the substrate is arranged with the contact surface pointing down. In this case, the substrate is arranged over the phosphor. A reverse arrangement is feasible.

The arrangement of phosphor, substrate and spacers can be placed in a clean room, e.g. a micro-clean room. In addition, the arrangement can be arranged on a rotational element, e.g. a rotational disk, e.g. one that can rotate slowly. It is feasible that the intermediate space between the substrate and the phosphor is flushed with, e.g. deionized, water or a fluid. This may have the effect that particles are flushed away and additionally a water-film can form, e.g. by way of capillary forces, between the phosphor and the substrate.

It is furthermore feasible for the arrangement to be subsequently dried, e.g. due to irradiation with infrared light. It is feasible here for the drying to be supported by fast rotation of the rotational element, e.g. using centrifugal force.

Subsequently, the spacers can be removed, in particular still in the clean room atmosphere, with the result that the part that is arranged at the top, i.e. the substrate or the phosphor, drops onto the part that is arranged at the bottom, i.e. onto the phosphor or the substrate. During the movement of the parts toward one another and/or before and/or afterward, an initial pressure can be applied on the upper component. This may be done on the side of the part that is subject to the initial pressure, for example in the range of 7 to 50 MPa, which side points away from the other part. Application of the initial pressure, which triggers what is known as a bonding wave, can e.g. take place approximately centrally on the upper part.

In various embodiments, using different methods, e.g. by way of cleaning and/or a wet chemical modification and/or by the accumulation of polymer films and/or organic molecules, the bonding energy can be significantly increased by thermal treatment even at temperatures below 500° C. This may be provided e.g. if the melting temperature for the dichroic layer on the substrate is 500° C.

By way of annealing, the chemical structure of the bonding boundary surface up to covalent bonds can be changed, and thus the bonding energy increased, if the bonding energy of the bonded materials does not suffice. This can be the case for example at room temperature.

According to various embodiments, a LARP system is provided which has a converter as described herein. The LARP system can furthermore have a radiation source for emitting excitation radiation. The excitation radiation can be at least partially or completely converted into conversion radiation by the converter.

Provided in accordance with various embodiments is a headlight, e.g. a vehicle headlight for a vehicle, having a LARP system in accordance with one or more of the preceding aspects.

Likewise feasible is the use of the headlight for effect illumination, entertainment illumination, architainment illumination, ambient illumination, medical and therapeutic illumination, horticulture etc.

The vehicle for which the headlight is intended can be an aircraft or a waterbound vehicle or a landbound vehicle. The landbound vehicle can be a motor vehicle or a rail vehicle or a bicycle. Furthermore, the use of the vehicle headlight in a truck or a passenger car or a motorbike may be provided.

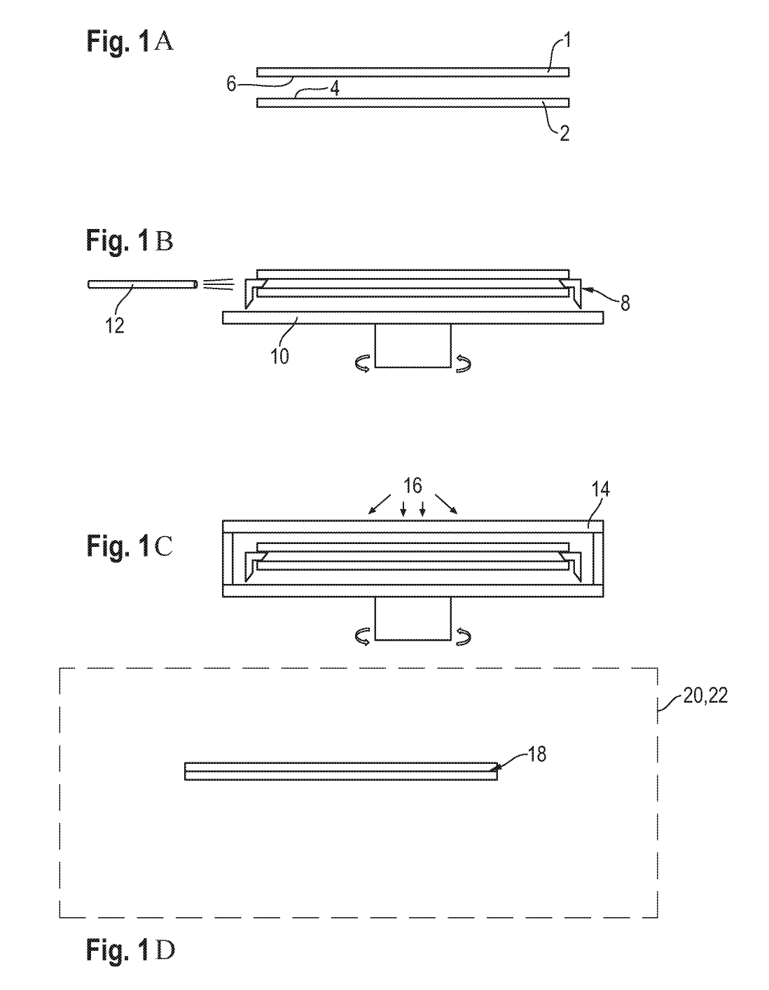

FIG. 1a to FIG. 1d show individual processes of the direct bonding process of the phosphor and of the substrate.

FIG. 1a shows the two components to be bonded, the substrate 1 and the phosphor 2, which are here e.g. in the form of plates and approximately have the same thickness, aligned with the contact surfaces 4, 6 to be bonded respectively facing one another. The contact surfaces 4, 6 to be bonded may have an identical size and shape. Here, the substrate 1 is arranged on top, but an inverted arrangement is possible. The substrate 1 may be a sapphire plate having a thickness of approximately 0.5 mm. The phosphor or the phosphor plate has a thickness of 100 to 400 μm.

FIG. 1b illustrates how substrate 1 and phosphor 2 are separated by spacers 8, and the entire arrangement is arranged on a slowly rotating rotatable element in the form of a disk 10. Using a waterjet 12 of deionized water, the region between the substrate 1 and the phosphor 2, i.e. the surfaces 4, 6 which are respectively to be bonded, is flushed. The rotation of the disk 10 results in a better distribution of the water.

In accordance with FIG. 1c, the arrangement of substrate 1, phosphor 2 and spacers 8 is dried in a micro-clean room 14 by way of irradiation with infrared light 16 and the quick rotation of the rotational disk 10. Water particles are flung out due to the rotation.

FIG. 1d shows a cross section of the bonded materials, the phosphor 2 and the substrate 1, which are fixedly connected to one another at the respective contact surfaces 4, 6, the bonding boundary 18. A bonding boundary 18 is then formed between the contact surfaces 4, 6. The arrangement can be part of a LARP system 20, which can be part of a headlight 22. The LARP system and headlight are illustrated in simplified fashion by way of a dashed line shown in FIG. 1d.

Disclosed is a converter for a laser-activated remote phosphor (LARP) system, having a substrate and a phosphor for converting excitation radiation. The phosphor/the substrate may be fixed to the substrate/the phosphor by way of direct bonding. Furthermore disclosed is a method by means of which the phosphor and the substrate are joined together by way of bonding.

### LIST OF REFERENCE SIGNS

substrate 1
phosphor 2
contact surface of the phosphor to be bonded 4
contact surface of the substrate to be bonded 6
spacer 8
rotational disk 10
waterjet 12
micro-clean room 14
infrared light 16
bonding boundary 18
LARP system 20
headlight 22

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A converter for a laser-activated remote phosphor system, comprising:
a phosphor for at least partially converting excitation radiation from a radiation source of the laser-activated remote phosphor system; and
a substrate on which the phosphor is fixed;
wherein the phosphor and the substrate are connected by way of bonding.

2. The converter of claim 1,
wherein at least one of the phosphor or the substrate are in the form of plates.

3. The converter of claim 1,
wherein a contact surface of the phosphor and a contact surface of the substrate are identical in size.

4. The converter of claim 3,
wherein the phosphor has an additional layer that has the contact surface.

5. The converter of claim 4,
wherein the additional layer, which the phosphor has, is a glass layer.

6. The converter of claim 3,
wherein the substrate has an additional layer that has the contact surface.

7. The converter of claim 6,
wherein the additional layer, which the substrate has, is a dichroic layer and the outermost stratum of the dichroic layer is a glass layer.

8. A method for producing a converter for a laser-activated remote phosphor system,
the converter comprising:
a phosphor for at least partially converting excitation radiation from a radiation source of the laser-activated remote phosphor system; and
a substrate on which the phosphor is fixed;
wherein the phosphor and the substrate are connected by way of bonding;
the method comprising:
connecting a phosphor and a substrate of the converter by way of bonding.

9. The method of claim 8,
wherein the substrate and the phosphor are coated on the contact-side with a layer from the same material.

10. The method of claim 8,
wherein the substrate and the phosphor are arranged at a distance from one another;
wherein contact surfaces thereof point toward each other, wherein the layers are arranged one on top of the other and extend in each case horizontally.

11. The method of claim 8, further comprising:
introducing spacers between substrate and phosphor so as to arrange these on top of each other;
removal of the spacers between substrate and phosphor, as a result of which the substrate and the phosphor come to rest against one another.

12. The method of claim 8, further comprising:
at least one of flushing particles or producing a water film between the substrate and the phosphor;
drying the phosphor and the substrate.

13. The method of claim 8,
wherein pressure is applied on the outer surface of the upper component that faces away from the contact surface.

14. A laser-activated remote phosphor system, comprising:
a converter, comprising:
a phosphor for at least partially converting excitation radiation from a radiation source of the laser-activated remote phosphor system; and
a substrate on which the phosphor is fixed;
wherein the phosphor and the substrate are connected by way of bonding.
